(19) United States
(12) Patent Application Publication
(10) Pub. No.: US 2013/0200000 A1
(43) Pub. Date: Aug. 8, 2013

(54) METHODS FOR TREATING WASTE WATERS USING SULFIDIZED RED MUD SORBENTS

(71) Applicant: Joseph Iannicelli, Brunswick, GA (US)

(72) Inventor: Joseph Iannicelli, Brunswick, GA (US)

(21) Appl. No.: 13/261,641

(22) PCT Filed: Dec. 21, 2011
(86) PCT No.: PCT/US11/02000

§ 371 Date: Apr. 16, 2013

Related U.S. Application Data
(63) Continuation-in-part of application No. 13/199,426, filed on Aug. 30, 2011, now Pat. No. 8,236,185.

(51) Int. Cl. B01J 20/02

(52) U.S. Cl. CPC B01J 20/02
USPC 210/663; 210/660; 210/690

(57) ABSTRACT

Sorbents prepared according to the invention useful in remediation of polluted effluents including waste waters and other fluids such as air, the invention is particularly directed to use of sulfidized red muds in treatment of sanitary waste waters to substantially remove or reduce bacterial levels such as fecal coliform as well as phosphates and total dissolved solids (TDS). The sulfidized red mud sorbents of the invention are derived by sulfidation of red mud, a waste product of Bayer processing of bauxite ores, red muds being sulfidized by reaction with sulfidizing agents including H₂S, N_{A2}S, K₂S, (NH₄)₂S and CaSₓ as examples. Sulfidized red muds used according to the invention typically exhibit a sulfur content from about 0.2 to about 10% above residual sulfur in the red mud used as the starting material for preparation of the sulfidized red mud sorbents used in the presently disclosed methods.

### CROSS REFERENCE TO RELATED APPLICATIONS

This application is a continuation-in-part of U.S. application Ser. No. 13/199,426, filed Aug. 30, 2011, which is a continuation-in-part of U.S. application Ser. No. 12/781,965, filed May 18, 2010, which is a division of U.S. application Ser. No. 12/537,907, filed Aug. 7, 2009, now U.S. Pat. No. 7,807,058, which is a division of U.S. application Ser. No. 11/277,282, filed Mar. 23, 2006, now U.S. Pat. No. 7,763,566, the disclosures of which are hereby incorporated by reference. The disclosure of U.S. application Ser. No. 12/796,066, filed Jun. 8, 2010, and being a continuation-in-part of application Ser. No. 11/277,282, filed Mar. 23, 2006, now U.S. Pat. No. 7,763,566, is also incorporated hereinto by reference.

### TECHNICAL FIELD

The present invention relates generally to sorbents and methods for use of said sorbents in the treatment of fluids such as waste streams to remove undesired contaminants contained therein and particularly for the facile remediation of waste waters including sanitary waste waters as well as other fluids through removal, reduction and/or extraction of species including bacteria and phosphorus as well as reduction of total dissolved solids (TDS) and for removal of heavy metals inter alia if said waste waters and other fluids are so contaminated.

### BACKGROUND ART

Treatments for removing or reducing concentrations of contaminants from water and other fluids polluted by such contaminants have been practiced throughout man's history. Contaminated water especially constitutes one of the most pressing public health problems worldwide. Literally millions of people perish annually or suffer poor health due to lack of water that is insufficiently clean to adequately support living beings. Waste water treatments have taken a variety of forms ranging widely in effectiveness and cost. The treatment of sanitary waste water in particular to the degree necessary to permit discharge into waterways is particularly costly but is essential due to the need to remove or reduce bacterial levels, contaminants such as phosphorous and dissolved solids known in the field as total dissolved solids or TDS. While known treatment methodologies are commonplace, a long-felt need in the art still exists in that effective methods capable of low-cost practice must be deployed especially in less developed regions where clean water is practically unavailable to a majority of the inhabitants.

Concurrent with this long-felt need for effective and low-cost treatment of waste waters and particularly sanitary waste waters is the need to effectively dispose of “red mud”, an undesirable by-product and major pollutant from the Bayer Process, the principal process for production of alumina. The Bayer Process solubilizes aluminous minerals in hot sodium hydroxide solution within which most remaining ore minerals are either insoluble or react and re-precipitate. The insoluble, iron-rich residual by-product of the Bayer Process is known as “red mud” and has differing chemical constituents dependent on ore composition. Red mud typically contains from about 10 to 40% iron oxide (Fe₂O₃) and is a complex mixture of finely divided hydrated iron oxides concurrent with a variety of minerals such as Al, Na Ti, Si, Ca, Mg, etc. as well as traces of Cr, Ni, Zn, Pb, As, etc. The hydrous iron oxides present in red muds have extraordinary sorptive and complexing properties but suffer from the drawback that red muds also leach toxic elements present in the original bauxite therefore reducing or even eliminating any utility red muds might otherwise possess as sorbents.

Due to an inability of aluminum producers to find a safe and effective use for the 200 million tons of toxic red mud waste produced annually world-wide, waste impounds for this noxious, toxic red mud by-product have been created around the world and now store an estimated two billion tons of this dangerous material for which no realistic uses have been devised since the beginning of bauxite processing, nearly 140 years and counting.

One particular example of an attempt to utilize red mud to control leaching of phosphate in run-off water from cattle pastures in Australia is described in an e-newsletter entitled “The Great Red Mud Experiment that Went Radioactive”, Gerard Ryle, May 7, 2002 (smh.com.au/articles/2002/05/06/1019441476548.html). This Alcoa experiment in association with the Western Australian Agricultural Department involved placing 20 tons of Alcoa red mud per hectare on farmland in an effort to prevent unwanted phosphorus from entering waterways. An unintended result was that excessive quantities of copper, lead, mercury, arsenic and selenium were leached from the red mud into run-off water resulting in emaciated cattle grazing on the treated land, the cattle exhibiting high chromium, cadmium and fluoride levels among other dangerous contaminants disastrous to the health of the grazing cattle and other living creatures. Each hectare further contained up to 30 kilograms of radioactive thorium. The experiment was terminated abruptly after five years. Obviously, red mud per se did not find utility as a sorbent in this effort to prevent run-off water contamination in an agricultural setting.

An experiment conducted in Australia by Virotec, a company founded by Dr. David McConchie, used a treated red mud as a sorbent for heavy metals, phosphates, cyanides, organic compounds and sanitary waste, the treatment of red mud prior to use involving removal of much of the toxic metals in the original red mud through an intensive series of washings with brines, typically sea water, of up to ten to twenty volumes of sea water per volume of red mud. This Virotec process requires a sea coast site with extensive washing and concentrating facilities coupled with the legal right to discharge extracts of heavy metals and other leachates into sea water. Discharge of these toxic substances into sea water is fraught with the peril of affecting fish, shellfish, sea life generally and even human activities and would be unlikely to meet environmental standards in most areas of the world. Thus, such processes are tedious, complicated, expensive and of limited application.

Other attempts to utilize red mud are exemplified by Yu et al in U.S. Pat. No. 4,560,465. In this patent, Yu et al disclose the presulfidizing of red mud using hydrogen and H₂S inter alia at temperatures ranging from about 200° F. to 3000° F. and pressures ranging from 50 to 3500 psig, these conditions being sufficiently severe to convert substantially all of the iron, namely, both Fe₂O₃ and the Fe, Al, Ca oxide hydrates, to pyrrhotite, Fe₁₋ₓSₓ, and particularly Fe₇S₈. The pyrrhotitic material thus formed is dehydrated and is not only less reactive as a sorbent than is red mud but is also essentially unreactive and useless as a sorbent. The pyrrhotitic materials of Yu et al are used as catalytic agents for cracking hydrocarbons, those materials apparently providing a more efficient hydrogen distribution for the catalysts of Yu et al, as noted in column 4, lines 36-40 of the aforesaid patent. The red mud products treated according to Yu et al are ineffective for use as sorbents of anything.

An article to Han et al in the Journal of Industrial Engineering Chemistry in 2002 described the use of red mud per se in combination with other materials as a sorbent and thus teaches no more than the previously known ability of red mud to sorb certain heavy metals and the like. Ordonez et al in Applied Catalysts B: Environmental 29 (2001) 263-273, treats red mud essentially as does Yu et al in the above description and thus does not produce an effective and safe sorbent.

The prior art has therefore failed to produce a use for red mud in the manufacture of a useful sorbent capable of efficiently sorbing contaminants from fluids and particularly waste water containing noxious pollutants such as bacteria in the form of fecal coliforms, phosphorus and dissolved solids (TDS). By contrast, U.S. Pat. No. 7,763,566, issued to the present inventor, discloses sorbents comprised of sulfidized red muds produced as reaction products of a sulfidizing compound and red mud, the sulfur content of the reaction products typically being from about 0.2 to about 10% above residual sulfur in the red mud. Exemplary sulfidizing compounds comprise H₂S, Na₂S, (NH₄)₂S and CaSₓ with sulfidizing conditions being such that pyrrhotitic material is not formed and is not present in the sorbents of the invention. The sorbents thus produced, labeled herein as sulfidized or sulfided red mud, are used according to the present invention to remediate waste fluids and particularly waste waters such as sanitary waste waters to remove or reduce bacterial species such as fecal coliforms, phosphorus and total dissolved solids.

### SUMMARY OF THE INVENTION

The sulfidized red mud sorbents useful in practice of the treatment methodologies of the present invention can take the form of those sorbents disclosed in U.S. Pat. Nos. 7,763,566 and 7,807,058, and include sulfidized red mud that has been filtered and dried such as by heating, spray drying, etc., or which have been subject to separation processes such as passive or active sedimentation or centrifugation prior to drying. Further, the sulfidized red mud sorbents so utilized can be present in slurries such as aqueous slurries including slurries emanating directly from a Bayer Process. Use of a slurried or “wet” sulfidized red mud avoids the cost of separation and drying and is therefore less expensive, more simple in use and exceedingly efficient.

Wet processed sulfidized red mud is particularly efficient for treatment of waste waters including sanitary waste water according to the present invention. Wet processed sulfidized red muds used in slurry form are also suitable for flue gas scrubbing and for treatment of acid mine waste as well as in the treatment of fluids including liquid and gaseous fluids. In such applications, a wet slurry of sulfidized red mud eliminates filtration and drying expense as well as the expense of dispersing dried sulfidized red mud in water prior to use.

Sorbents so used are reaction products of red muds and sulfidizing compounds such as H₂S, Na₂S, K₂S, (NH₄)₂S and CaSₓ. The sulfur content of the reaction products typically is from about 0.2 to about 10% above the residual sulfur in the original red mud. Reaction conditions range from ambient temperatures to approximately 100° C. and pressures ranging from atmospheric pressure to approximately 100 psig. The conditions of sulfidization thus producing the sorbents useful according to the present invention does not result in the formation of pyrrhotites thus allowing the resulting sorptive reaction products to exhibit maximum sorptive abilities. The weight ratio of sulfidizing compound to red mud can vary according to the sulfidizing compound used as well as the desired degree of sulfidization for a particular end use. Typically, the sulfidizing compound and red mud are combined at a weight ratio of from about 1:40 to about 1:4 and more usually from about 1:25 to about 1:6 and even more usually from about 1:20 to about 1:8.

Waste waters treatable according to the invention range from contaminated waters including sanitary waste waters, mine drainage waters, mine runoff, agricultural runoff and the like and produces water of a purity permitting discharge into waterways and even for direct use as potable water. Non-aqueous liquid streams can also be treated according to the invention.

Waste gaseous streams can also be treated using the sulfidized red mud sorbents used for waste water treatment, such gaseous streams including flue gases from oil- or coal-fired power plants and waste effluents from municipal waste combustors, hazardous waste combustors, hospital waste combustors, cement kilns and industrial incinerators inter alia.

Sulfidized red mud is therefore useful according to the present invention as an effective sorbent for removing a wide variety of noxious materials from fluids ranging from contaminated water to flue gases and the like while permitting more facile recycling of at least portions of the caustic liquors to aluminum production.

Accordingly, it is a primary object of the invention to provide methods for treatment of fluids with sulfidized red mud to sorb contaminants from such fluids.

It is another object of the invention to treat waste water with sulfidized red mud to sorb pollutants from said waters to a degree allowing discharge of the treated waters into the environment.

It is yet another object of the invention to provide methods for treatment of waste water to sorb contaminants therefrom to result in potable water.

It is a further object of the invention to provide methods for treatment of sanitary waste waters to remove or reduce bacterial levels including levels of fecal coliforms as well as phosphorous and total dissolved solids (TDS).

It is a still further object of the invention to provide methods for treatment of waste fluids to remove contaminants with sulfidized red mud sorbents devoid of pyrrhotitic materials.

Further objects and advantages of the invention will become more readily apparent in light of the following detailed description of the preferred embodiments.

### DESCRIPTION OF PREFERRED EMBODIMENTS

The sulfidized red mud sorbents disclosed in U.S. Pat. No. 7,763,566 in the various physical forms therein described are useful according to the present invention for treatment of fluids to remove contaminants and particularly pollutants from waste waters such as sanitary waste waters. The sulfidized red mud sorbents of U.S. Pat. No. 7,763,566 can also be used in slurry form, such as an aqueous slurry without separation and drying, the slurry being commingled with the fluid to be treated. The invention particularly contemplates preparation of potable water meeting drinking water standards through treatment of polluted waste water such as sanitary waste water by sorption using the sulfidized red mud sorbents herein disclosed in the several forms as described.

Sulfidizing of red muds to produce the sulfidized red mud sorbents used in the methodologies of the present invention is achieved by reacting red muds with one or more sulfidizing compounds such as H₂S, Na₂S, K₂S, (NH₄)₂S and CaSₓ under conditions such as temperatures ranging from ambient to 150° C. and pressures ranging from atmospheric pressure to about 100 psig. The resulting sulfidized red muds typically exhibit a sulfur content from about 0.2 to about 10% above the residual sulfur content of the red mud. The weight ratio of sulfidizing compound to red mud varies according to the sulfidizing compound used and the desired degree of sulfidization for a particular end use. The sulfidized red muds so used are not prepared under conditions that will result in the presence of pyrrhotitic material in the sorbents since sorbing ability would be reduced. Unlike red mud, which is very hydrophilic, sulfidized red muds used according to the present invention are lyophobic and more easily dewatered than is red mud.

In preparation of the sulfidized red mud sorbents used in practice of the present methodologies, reaction conditions depend on factors such as the sulfidizing compound or compounds and the intended use of the sorbents. Sulfidization can be accomplished by the simple mixing of red mud with the sulfidizing compound at ambient temperature and atmospheric pressure. In general, higher sulfur contents are obtained when reaction is carried out at more elevated temperatures and/or more elevated pressures. Sulfur content in the reaction product can be influenced by the sulfur content of the sulfidizing compound. Sulfidizing compounds with higher sulfur content such as calcium polysulfide typically yield sorbents having higher sulfur content.

When using gaseous sulfidizing compounds such as H₂S, it is preferable to conduct reaction at more elevated temperature or more elevated pressure to increase reaction rate and therefore the sulfur content of the resulting sorbent, suitable exemplary reaction temperatures ranging from about 40° C. to less than 200° C. and normally from about 80° C. to about 120° C. Reaction pressures range typically from about 1 to about 224 psi and normally from about 30 to about 70 psig (absolute).

Sulfidized red mud can be produced by treating red mud exiting a bauxite treatment step or after an initial storing of a red mud/caustic slurry, treatment being with a sulfidizing compound as herein disclosed. Such treatment permits more facile recycling of at least portions of caustic liquor occurring as a portion of the red mud by-product due to the resulting sulfidized red mud having a less hydrophilic nature than does red mud per se. Accordingly, sulfidized red mud can be removed from the caustic liquor more easily by static sedimentation in settling ponds or by accelerated sedimentation such as by use of hydroclassifiers including centrifugal or cyclonic classification than can red mud per se. Sulfidized red mud can also be more easily removed from the caustic liquor by filtration than can red mud.

Treatment according to the present invention of waste water to reduce or remove phosphates, TDS including organic material and bacteria such as fecal coliforms is effected by the use of sulfidized red mud. In such treatment it is preferred to admix a slurry of sulfidized red mud with the waste water followed by separation of the sulfidized red mud and sorbed contaminents by separation processes including filtration, centrifugation or sedimentation including static sedimentation such as settling or accelerated sedimentation such as by hydroclassisfication. Use of sulfidized red mud in slurry form directly after sulfidization without filtering or drying is preferred for most use applications according to the invention.

A slurry of sulfidized red mud such as can be produced by sulfidization of red mud after discharge from a Bayer Process exhibits enhanced utility relative to dried sulfidized red mud due to cost savings occurring through avoidance of filtration and drying stages, retention of high alkalinity as can be reduced in a filtration step, and ease of shipping, processing and mixing with a fluid which is to be treated with sulfidized red mud. In uses according to the invention, “wet” slurries of sulfidized red mud can be used directly by bringing the slurry into contact with the contaminated fluid from which contaminants are to be removed. Shipping of sulfidized red mud slurries is comparable in cost to shipping of dried sulfidized red mud. Suitable mixing equipment of conventional nature can be used to provide sufficient contact between the sulfidized red mud sorbents and the contaminated fluid. The sorbent then containing the contaminant or contaminants can then be separated from the slurry using conventional techniques.

Alternatively, sulfidized red mud sorbents are processed into pellets after separation and drying stages, the pelletized sorbents being usable as filters of conventional construction such as in filters usable for preparing potable water.

### EXAMPLES

### Example 1

This example shows the preparation of red mud. A 1 kg sample of red mud received from Sherwin Alumina Company of Corpus Christi, Texas was slurried at 15% solids in demineralized water and filtered on a Buchner funnel. The resulting filter cake was re-slurried with demineralized water, re-filtered, and used as the starting material in Example 2. The red mud thus prepared is used as detailed herein in certain subsequent examples.

### Example 2

This example illustrates the preparation of sulfidized red mud using hydrogen sulfide (H₂S). Washed red mud (100 g) from Example 1 was slurried in demineralized water at 15% solids and the stirred slurry was saturated with hydrogen sulfide for 30 minutes at ambient temperature. The sample was dried overnight at 100° C. and the resulting cake was pulverized.

### Example 3

This example shows the preparation of sulfidized red mud using H2S under pressure in a Parr Bomb. The sulfidation procedure of Example 2 was repeated using a Laboratory Parr Bomb. After saturation of the slurry with hydrogen sulfide gas, the bomb was sealed and heated four hours at 100° C. while stirred. The bomb was then cooled, depressurized and the contents filtered, dried, and pulverized.

### Example 4

This example illustrates the preparation of sulfidized red mud using ammonium sulfide (NH₄)₂S. Red mud (200 g) was dispersed in 600 grams of deionized (DI) water in a Waring Blender for 5 minutes. Ammonium sulfide (10 g) was added and the slurry was heated with stirring on a hot plate for 1 hr. at 60° C. It was then filtered and dried at 90° C.

### Example 5

This example shows the preparation of sulfidized red mud using sodium sulfide (Na₂S). The procedure of Example 2 was repeated using sodium sulfide instead of ammonium sulfide.

### Example 6

The procedure detailed in Example 1 was repeated with substitution of red mud received from Noranda Aluminum Company of Gramercy, Louisiana for the red mud received from Sherwin Alumina Company. The Noranda red mud was analyzed for moisture content and found to be 53.8% solids. Two slurries of the Noranda red mud having 25% solids with volumes of six (6) liters were made up, the weight of each slurry being approximately 7.54 kilograms. The slurries were respectively referred to as Sample A and Sample B. Sample A was mixed at high speed for four hours using a laboratory stirrer. The pH of Sample A was measured to be 10.34. Sample B was treated with 500 grams of 20% ammonium sulfide solution and the admixture was heated to 60° C. for one hour and allowed to cool to room temperature. The resulting slurry containing sulfidized red mud exhibited a pH of 9.48, this sulfidized slurry being referred to as sulfidized Sample B. A portion of Sample A and a portion of sulfidized Sample B were each vacuum filtered, the filtrates reslurried to 25% solids and spray dried. Particle size analysis of the resulting spray dried materials indicated no significant difference in particle sizes in the two resulting slurries.

### Example 7

In preparation for testing of Sample A and Sulfidized Sample B for Example 6, 10 ml of 0.14N mercury (II) nitrate solution was added to 5 liters of distilled water. One liter of the resulting solution was reserved as a control designated hereinafter as 062711-A.

### Example 8

Sample 062711-B was prepared to contain 40 grams of 25% solids sulfidized red mud slurry taken from Sulfidized Sample B from Example 6. Sample 062711-B, unfiltered and undried, was diluted to one liter of liquid using water.

### Example 9

Sample 062711-C was prepared to contain 10 grams of filtered and spray dried material derived from Sulfidized Sample B from Example 6 in one liter of water.

### Example 10

Sample 062711-D was prepared to contain 40 grams of 25% solids taken from Sample A from Example 6, the slurry of Sample A not having been filtered or dried, in one liter of distilled water.

### Example 11

Each of the Samples prepared in Examples 7 through 10 were mixed in a Waring Blender for 5 minutes, filtered using Whatman 54 paper, and filtered once more using a Millipore filter equipped with a membrane with 2cc of 70% nitric acid being added to each sample as a stabilizer prior to shipment for resting at Altamaha Laboratories.

Table I provides mercury sorption test results:

TABLE I

| | Mercury | |
|---|---|---|
| Sample | ppm | |
| 062711-A | 37.00 | Control |
| | | 10 ml of 0.14N Mercury (II) Nitrate solution |
| | | added to 10 kilograms of distilled water |
| 062711-B | 0.000919 | Sulfidized Red Mud Slurry: Not Filtered or Dried |
| | | 40 grams of 25% solids sulfidized red mud |
| | | slurry diluted to one liter of slurry |
| 062711-C | 0.0874 | Sulfidized Red Mud Slurry: Filtered and Dried |
| | | 10 grams of filtered and spray dried sulfidized |
| | | red mud diluted to one liter of slurry |
| 062711-D | 2.27 | Red Mud Slurry: Not Filtered or Dried |
| | | 40 grams of 25% solids red mud slurry diluted to |
| | | one liter of slurry |

Conclusions evident from Table I are that sulfidized red mud that is not filtered and dried, Sample 062711-B, was approximately ten times more efficient in sorbing mercury than the same slurry that was previously filtered and dried, Sample 062711-C. Both samples 062711-B and 062711-C were significantly more efficient in sorbing mercury compared to unsulfidized red mud, Sample 062711-D.

Two slurries of ten grams each respectively of spray dried red mud and spray dried sulfidized red mud in one liter of distilled water were prepared using a Waring blender for five minutes. Each slurry was poured separately into a Buchner funnel equipped with a Whatman 54 paper and vacuum was applied. Filtration of the liquid from the slurry of red mud required 17.5 minutes while filtration of the liquid from the sulfidized red mud slurry required 5.0 minutes.

Red mud has previously been suggested as a component of a sorbing agent for wastewater treatment. Lopez et al in Wat. Res. Vol. 32, No. 4, pp. 1314-1322, 1998 combined red mud with CaSO₄ to form aggregates stable in aqueous media, these aggregates being used to sorb impurities from wastewater streams. However, Lopez et al did not address the problem of heavy metal shedding from such aggregates or from red mud itself when used as a sorbent particularly in aqueous systems.

Use of sulfidized red mud for treatment of waste effluent streams and particularly waste waters including sewage at various stages of treatment improves over the use of red mud whether or not aggregated with other substances by the fact that sulfidized red mud does not release heavy metals into the effluent streams. As noted herein, the use of sulfidized red mud in effluent treatment including wastewater treatment such as sewage treatment exhibits a number of other significant advantages and improvements over prior sorbing processes and agents.

Sulfidized red mud as disclosed herein is particularly useful in the treatment of sanitary waste water in the removal or reduction of TDS (Total Dissolved Solids) and phosphorus. Such treatment of sanitary waste water from typical oxidation ponds results in reduction of TDS and P, results consistent with the sorptive properties of sulfidized red mud for various contaminants in water. As with uses previously described and as described herein, a red mud slurry can be directly sulfidized and used as produced without filtration or drying.

### Example 12

Wastewater from Oxidation Pond 1 at New Hope Plantation Mobile Home Park (raw sewage) was shaken with 10% by weight of sulfidized red mud containing 25% solids plus 5% ammonium sulfide (based on red mud) for 10 minutes and then dewatering the red mud. This treatment reduced TDS, P, and Fecal Coliform below detection limits. Results are summarized in Table II.

TABLE II
(Tindall Enterprises/Altamaha Laboratories, Blackshear, GA)

| | | | Treated with | Detection |
|---|---|---|---|---|
| | Units | Untreated | SRM | Limit |
| TDS | mg/l | 104 | <5.0 | 5.0 |
| P | mg/l | 1.79 | <0.1 | 0.1 |
| Fecal Coliform | mpn/100 ml | >1600 | <2.0 | 2.0 |

### Example 13

The procedure of Example 12 was followed except that Pond 1 Samples and Pond 2 Samples were treated with slurries that had been dried at 100° C. overnight. Results show that the sulfidized red mud slurry was considerably more active than the same slurry that had been dried before testing.

| Fecal coliforms, col/100 ml | Average Value |
|---|---|
| Untreated Pond 1 | 38,500 |
| Untreated Pond 2 | 14,300 |
| Sulfidized Red Mud - Treated Pond 1 | 0 |
| Sulfidized Red Mud - Treated Pond 2 | 10 |
| Dried Sulfidized Red Mud - Pond 1 | 535 |
| Dried Sulfidized Red Mud - Pond 2 | 985 |

### Example 14

Sorption of Mercury II by Wet Process. Sulfidized Red Mud (WPSRM) vs Dried Sulfidized Red Mud (DSRM) vs Red Mud Sllurry (RM). Test data is summarized in Table IV and shows that Wet Processed Sulfidized Red Mud reduced Hg II down to less than 1 ppb compared to Dried Sulfidized Red Mud which reduced Hg II to about 90 ppb. This shows a striking advantage of the West Processed Sulfidized Red Mud over Dried Sulfidized Red Mud. It is of interest that the dried sulfidized red mud only reduced Hg II down to 2.27 ppm (2,270 ppb).

TABLE III
Mercury Sorption Testing Results

| | | Sample | Mercury | |
|---|---|---|---|---|
| Date | Time | Description | ppm | |
| Jun. 27, 2011 | 13:00 | 062711-A | 37.00 | Control |
| | | | | 10 ml of 0.14N |
| | | | | Mercury (II) |
| | | | | Nitrate Solution |
| | | | | was added to |
| | | | | 10 kg distilled water |
| Jun. 27,2011 | 14:00 | 062711-B | 0.000919 | SRM Slurry: Not |
| | | | | Filtered or Dried |
| | | | | 40 grams of 25% |
| | | | | solids SRM slurry |
| | | | | (not filtered or dried) |
| | | | | to one liter of |
| | | | | distilled water |
| Jun. 27, 2011 | 15:00 | 062711-C | 0.0874 | SRM Slurry: |
| | | | | Filtered + Dried |
| | | | | 10 grams of filtered |
| | | | | and spray dried SRM |
| | | | | to one liter of |
| | | | | distilled water |
| Jun. 27, 2011 | 16.00 | 062711-D | 2.27 | RM Slurry: Not |
| | | | | Filtered or Dried |
| | | | | 40 grams of 25% |
| | | | | solids RM slurry |
| | | | | (not filtered or |
| | | | | dried) to one liter |
| | | | | of distilled water |

As taught in U.S. application Ser. No. 12/796,066, filed Jun. 8, 2010, by the same inventor and incorporated in its entirety hereinto by reference, high quality water suitable for distribution and consumption by humans and animals as well as for use in industrial processes is produced by the removal of discolored organic compounds through use of sulfidized red mud as an effective sorbent. Discolored organic compounds are contaminants of aqueous streams such as discharges from food processing, mining waste inter alia as well as transportation, sewage and storm runoff. Environmental regulations have been enacted to assure aesthetic appearance of public waterways by setting color standards for industrial discharges such as from paper mills and the like.

Removal or reduction of concentrations of discolored organic compounds is accomplished according to present teachings in a manner similar to that disclosed herein for treatment of waste waters for removal of a variety of contaminants present in water.

Compounds considered to be undesirable discolored organic compounds include but are not limited to humic acids, fulvic acids, tannins and organic compounds formed by degradation of plant residues as well as organic compounds formed during industrial processes such as pulping and paper manufacture. These compounds and materials are very hydrophilic and not easily separated from water. Other natural and industrial contaminants found in surface and subsurface water include phthalates, bisphenol compounds, hormones, insecticides, herbicides and pharmaceutical and illicit drug residues. Removal of such compounds by readily operable and low cost processing is possible through treatment of aqueous solutions containing such compounds and materials as described herein.

Treatment of a medium containing discolored organic compounds as well as other contaminants is effected by contacting the medium with a sorbent comprising sulfidized red mud and separating the sorbent from the medium. The sorbent, containing adsorbed contaminants, can be separated from the medium using techniques including sedimentation, filtration and centrifugation. A sorbent containing or comprising sulfidized red mud can be slurried with the medium containing contaminants. The sorbent can alternatively be provided in the form of pellets or the like through which the medium is passed. Amounts of sulfidized red mud used in processing can vary over a wide range depending on factors such as the identity and relative amounts of the contaminant or contaminants present in the medium. Relatively small quantities of discolored organic compounds, for example, can be effectively sorbed with relatively small quantities of sulfidized red mud. By way of example, the amount of sulfidized red mud may range from about 0.005 to be 0.5 grams per milliliter of medium and often ranges from about 0.01 to about 0.1 gram per milliliter.

The extent to which a contaminant or contaminants may be removed from a medium will vary depending on such factors as whether the process is intended to produce potable water. The extent of removal may be quantified using any known technique. In the case of removal of discolored organic compounds, colorimetric scales are typically used, such as color value (CV) and/or absorbance. The extent of removal of contaminants may be increased, for example, by implementing multiple passes or stages as needed to achieve desired optical properties and/or purity.

### Example 15

This example illustrates clarification of Okefenokee Swamp water with sulfidized red mud. 500 ml of Okefenokee Swamp water (Sample I) was adjusted to pH 7 with dilute NaOH and mixed with 10 grams of sulfidized red mud (SRM) made with 10% ammonium sulfide in a Waring blender at high speed for 5 minutes. The mixture was transferred to a beaker and allowed to stir an additional hour using a magnetic stirrer. The suspension was filtered and the color value of the filtrate was determined with a LaMotte TC-3000e colorimeter. Another 10 grams of sulfidized red mud (SRM) was then added and the procedure was repeated a second time (2^{nd} Pass). The filtrate was again evaluated for color. Results are given in Table IV and showed that the treated sample was nearly colorless.

TABLE IV
Absorbance Testing of Okefenokee “Black” Water (Sample I)

| Sample Designation | Color Value (CV) (375 mm) |
|---|---|
| Control (untreated) | 347 |
| 1^{st} Pass SRM | 38.9 |
| 2^{nd} Pass SRM | 18.8 |

Another sample of Okefenokee “Black” Water (Sample II) was treated with sulfidized red mud according to the above procedure. The absorbance was reduced 90% to nearly colorless, as shown in Table V.

TABLE V
Absorbance Testing of Okefenokee “Black” Water (Sample II)

| Sample Designation | Absorbance* |
|---|---|
| Control (untreated) | 0.063 |
| Sample II | 0.0063 |

*Fisher Genesys5 Spectrophotometer 500 mm

While particular embodiments of the present invention have been described and illustrated, it should be understood that the invention is not limited thereto since modifications may be made by persons skilled in the art. The present application contemplates any and all modifications that fall within the spirit and scope of the underlying invention disclosed and claimed herein.

1. A sorbing process for treating a fluid containing contaminants which are to be removed, comprising the steps of:
contacting the fluid with sulfidized red mud to sorb the contaminants; and,
separating the sulfidized red mud and sorbed contaminants from at least portions of the fluid.

2. The process of claim 1 wherein the fluid is waste water containing phosphates, total dissolved solids including organics and bacteria.

3. The process of claim 1 wherein the sulfidized red mud exists as an aqueous slurry.

4. The process of claim 1 wherein the separating step comprises static sedimentation or accelerated sedimentation.

5. In a process wherein bauxite ores are treated in the production of alumina with a red mud slurried in a highly caustic liquor being produced as a by-product, the improvement comprising the steps of:
sulfidizing the red mud slurried with the caustic liquor to form a slurry of sulfidized red mud and caustic liquor; and,
separating the sulfidized red mud from at least portions of the caustic liquor.

6. In the process of claim 5 wherein the improvement further comprises the steps of recycling the at least portions of the caustic liquor to treatment of the bauxite ores.

7. In the process of claim 5 wherein the separating step comprises static sedimentation.

8. In the process of claim 5 wherein the separating step comprises accelerated sedimentation by centrifugal or cyclonic hydroclassification.

9. In the process of claim 5 wherein the improvement further comprises placing the sulfidized red mud and at least portions of the caustic liquor in a settling pond.

10. In the process of claim 5 wherein the improvement further comprises the step of contacting the sulfidized red mud with waste water from which at least certain contaminants are to be removed or reduced through contact with the sulfidized red mud.

11. A sorbing process for treating sanitary waste water containing contaminants which are to be removed or reduced, comprising the steps of:
contacting the sanitary waste water with sulfidized red mud to sorb the contaminants; and,
separating the sulfidized red mud and sorbed contaminants from at least portions of the sanitary waste water.

12. The process of claim 11 wherein the contaminants are selected from the group consisting of fecal coliform bacteria, phosphorus and discolored solids.

13. A process for preparing a sorbent slurry comprising reacting a sulfidizing compound with red mud at a reaction temperature from ambient to about 100° C. and a reaction pressure from atmospheric pressure to about five atmospheres.

14. The process of claim 13 wherein the sulfidizing compound is selected from the group consisting of H₂S, Na₂S, K₂S, (NH₄)₂ S and CaSₓ.
